(19) United States
(12) Patent Application Publication
(10) Pub. No.: US 2020/0187430 A1
(43) Pub. Date: Jun. 18, 2020

(54) HELICAL ARTIFICIAL GENERATOR OF TORNADO, HURRICANE, YELLOW DUST, AND TYPHOON

(71) Applicant: Young chul YANG, Seoul (KR)

(72) Inventor: Young chul YANG, Seoul (KR)

(21) Appl. No.: 16/621,441

(22) PCT Filed: Sep. 21, 2018
(86) PCT No.: PCT/KR2018/011339

§ 371 Date: Dec. 11, 2019

(30) Foreign Application Priority Data
Oct. 18, 2017 (KR) 10-2017-0135253

(51) Int. Cl. A01G 15/00; H02S 10/12; H02S 40/44; F03D 9/25

(52) U.S. Cl. CPC A01G 15/00; F03D 9/25; H02S 40/44; H02S 10/12

(57) ABSTRACT

The present invention provides a spiral artificial generator for the artificial generation of a tornado, a hurricane, yellowdust, or a typhoon, wherein the diameter D of the spiral artificial generator is selected by a basic module formula D=0.382H, a module formula H=2.618D is used when the diameter D of the spiral artificial generator is selected first, funnel-shaped arresters made of silver (Ag) are basically installed at a top of the spiral artificial generator, a solar cell heat collecting plate is installed on the outer wall of the top, and a door configured to be selectively opened and closed by solar cells and wind power generation, a blower configured to blow air to the artificial generator, and a stainless steel plate and heating coil configured to heat the inner walls of the paths are installed on the bottom of the spiral artificial generator.

### TECHNICAL FIELD

The present invention is a technology that provides artificially generated energy which can reduce or adjust the size and number of tornadoes, hurricanes, typhoons and yellowdust by utilizing air convection, the law of causality, the principle of gears, the Torricelli principle, the Pascal principle, the butterfly effect, the Ekman spiral principle, the Bernoulli's equation, the Boyle Charles' law, the Newton's law, etc. and weakening the generation energy of a tornado, a hurricane, a typhoon and yellowdust which are frequently generated in North America, Asia, and the Three Oceans while artificially dispersing them without interruption by the same generation principle, and a technology regarding a spiral artificial generator that is configured such that three passages are formed coaxially between four spiral cylinders to which stepped spiral blades are attached at an angle of 45° (height=width) according to the spiral principle in order to induce the heating of air, the raising of air, and a raised direction and which is operated and controlled year-round without interruption regardless of season and air mass by solar cells and wind power generation, wherein the size of the spiral artificial generator can be increased or decreased according to the basic module.

### BACKGROUND ART

The background art of the present invention is a technology that can generate a small artificial tornado, yellowdust or typhoon, which can artificially weaken the energy generated by the tornado, yellowdust or typhoon while dispersing it without interruption, in accordance with the Butterfly effect, such as the Pascal principle stating that “a flap of the wings of a small butterfly may someday be the cause of a typhoon” in meteorology, the law of causality stating that “even when a cause is very weak, a result comes” and the principle of gears year-round without interruption, and the principle of chimneys that the force by which a chimney sucks air is proportional to the height of the chimney and wind power energy is proportional to the third power of wind speed, and the wind energy is the chimney principle, which is proportional to the third power of the wind speed, the aerodynamic principle in which air heated by solar energy attempts to maintain a dynamic equilibrium, the principle of gears, the Torricelli principle, the Ekman principle, the Pascal principle (butterfly effect), the Bernoulli's equation, the Boyle-Charles' law and the Newton's law are also the background art. A cyclone rises counterclockwise in the northern hemisphere as shown in FIG. 1 while rising spirally counterclockwise as shown in FIG. 2, an anticyclone rotates clockwise, and a tornado, a hurricane, yellowdust, or a typhoon, which can be exemplified in FIG. 3 showing the section of a typhoon, moves while rotating in a counterclockwise direction, which is the direction of the arrows, and the portion around the eye, which is the center of the typhoon, descends from the top to the bottom.

On the assumption that natural tornadoes, hurricanes, yellowdust, and typhoons can be adjusted if a spiral generator is constructed to function in a manner similar to the above-described manner on land or at sea where it is necessary to reduce the damage of typhoons and then generation energy, which can generate a small artificial tornado, hurricane, yellowdust, or typhoon, can be continuously supplied in the form of powerful wind speed without interruption, the inventors note that powerful rising air such as a tornado, a hurricane, yellowdust, or a typhoon can be implemented using a spiral artificial generator, and air column-shaped rising air such as a small artificial tornado, hurricane, yellowdust, and typhoon can be generated using the spiral artificial generator year-round without interruption by means of the principle of gears of the spiral artificial generator, the Torricelli principle, the Pascal principle, the spiral movement principle, and the principle of chimneys.

A spiral artificial generator is constructed on land or at sea in a westerly wind area where the atmosphere is very unstable or in a trade wind (easterly wind) area where the water temperature is high, and continuously generates artificial rising air in the form of a tornado, yellowdust or typhoon. The upper wind speed that is discharged by continuously passing the surrounding ground air through the spiral artificial generator of the present invention exceeds the wind speed of a tornado, a hurricane, yellowdust, or typhoon that occurs naturally due to an anticyclone drop attributable to the horizontal accumulation of cyclones.

The wind speeds the spiral artificial generator of the present invention that are capable of generating a small artificial tornado, hurricane, yellowdust, or typhoon are calculated by the following formula.

The average minimum atmospheric pressure in terms of meteorological observations is 873 hPa. Accordingly, when the central air pressure of the spiral artificial generator is set to 943 hPa (=(873+1,013)÷2), which is the average of the lowest and standard air pressures, the diameter of the horizontal area of the cylindrical portion of air which can be continuously sucked by the spiral artificial generator from the ground and the height h of the cylindrical portion is 152 m, the wind speed Vw is calculated as follows:

In Vw=\sqrt{2P/ρ+2gh} quoting the Torricelli principle (potential energy) and the Bernoulli's equation P+ρgh+½=ρV²=Constant, Vw₁=\sqrt{2p/p} (kinetic energy) and Vw=\sqrt{2gh} (potential energy; the Torricelli principle) are obtained. In this case, P is the pressure difference, ρ is the density of air (1.2 kg/m²), g is the acceleration of gravity (9.8 m/s²), and h is the height. The Bernoulli's equation P+ρgh+½ρV²=Constant states that the relationship (the relationship between the kinetic energy and the potential energy) forms a constant value, and thus P₁+ρ₁g₁h₁+(½)ρ₁(v₁)²=P₂ ρ₂g₂h₂+(½)ρ₂(v₂)² at specific two points A1 (somewhere far from the center of a cyclone) and A2 (the center of the cyclone). Accordingly, when the above equation is arranged by transposition or the like in order to calculate the wind speed V₂ of the center point of a cyclone from the above, it can be seen that (½) [ρ₂(v₂)²−ρ₁(v₁)²]=(P₁−P₂)+(ρ₁g₁h₁+ρ₂g₂h₂). When some assumptions are made and it is assumed that the wind speed v₁ at point A1 at one atmosphere is v₁≈0 in which the wind speed v₁ is almost zero, the above equation becomes (½) [ρ₂(v₂)²]=(P₁−P₂)+(ρ₁g₁h₁−ρ₂g₂h₂). Furthermore, when it is possible to assume that the air density and the gravity acceleration at two points A1 and A2 are ρ₁≈ρ₂=ρ and g₁≈g₂=g, respectively, the above equation becomes (½) [ρ(v₂)²]=(P₁−P₂)+(ρgh₁−ρgh₂), and is rearranged to v₂=[[2(P₁−P₂)/ρ]+[2g(h₁−h₂)]^{1/2}. In this case, when the pressure difference P₁−P₂=P at two points and the height difference h₁−h₂=h at two points are applied, v₂=[[2P/ρ]+[2gh]]^{1/2}≈V_{ω} is obtained.

The difference between the standard atmospheric pressure and the central pressure of the spiral artificial generator is P=1,013 hPa−943 hPa=70 hPa=0.7×10⁴ N/m². When the height of the spiral generator is 152 m, the air pressure difference is 1 hPa per 10 m. Accordingly, P=152m×0.1 hPa/m=15.2 hPa=1.52×10³ N/m², the maximum wind speeds (Vw) sucked into the spiral generator are calculated as Vw=\sqrt{2×7,000/1.2+2×9.8×152}≈121 (m/s) and Vw=\sqrt{2×1,520/1.2+2×9.8×152}≈74 (m/s), and the maximum wind speed by the potential energy (the Torricelli principle) is calculated as 55 m/s V_{w2}=\sqrt{2gh}.

The wind speed calculated by the air pressure difference is 59˜60% efficient, so the wind speed (Vw) of 152 m high spiral artificial generator is calculated as Vw=0.6×121 (m/s)≈72 (m/s) or 0.6×74 (m/s)≈44 (m/s) when a wind speed efficiency of 60% is applied. When the actual efficiency achievable by the spiral artificial generator is calculated by applying 70% in consideration of the resistance of the spiral motion to the spiral artificial generator, Vw=0.7×V=0.7×72 (m/s)≈60 (m/s) or 0.7×44 (m/s)≈31 (m/s) is obtained.

The observed data for tornadoes, hurricanes, yellowdust, and typhoons are shown in Table 1:

TABLE 1

| Item | Tornado | Hurricane | Yellowdust | Typhoon |
|---|---|---|---|---|
| 1. Air | cyclone | tropical | polar | tropical |
| pressure | (cumulonimbus) | cyclone | cyclone | cyclone |
| 2. Temperature | 23 or | 27 or | 11 or | 26 or |
| (° C.) | higher | higher | higher | higher |
| 3. Latitude | 25 to 55 | 5 to 25 | 20 to 55 | 5 to 20 |
| | north | north | north | north |
| | latitude | latitude | latitude | latitude |
| 3. Latitude | 15 to 45 | 5 to 20 | 30 to 40 | 5 to 15 |
| | south | south | south | south |
| | latitude | latitude | latitude | latitude |
| 4. Number of | 1 to | 8 to 12 | 6 to 26 | 21 to 36 |
| occurrences | 1,000 | | | |
| 5. Period | January to June | July to October | March to May | June to September |
| 6. Duration | 10 to 90 | 5 to 20 | 1 to 6 | 4 to 15 |
| | minutes | days | days | days |
| 7. Altitude | 3 km | 12 km | 2 km | 6 km |
| 8.Initial wind | 23 m/s or | 29 m/s or | 9 m/s or | 17 m/s or |
| speed | more | more | more | more |

The wind speeds which generate tornadoes, hurricanes, yellowdust and typhoons range from 9 m/s to 29 m/s, as shown in Table 1 above, and a linear artificial generator can generate maximum wind speeds ranging from 31 m/s to 50 m/s as described above. The introduced air is continuously heated without interruption by means of the principle of chimneys, the principle of gears, the Torricelli principle, the Pascal principle (the butterfly effect), the Bernoulli's equation, the Boyle-Charles' law, the Ekman spiral principle, the heat generation of the spiral artificial generator, environmentally-friendly solar cells, and wind power generation. Accordingly, the efficiency of the spiral artificial generator exceeds sensory efficiency (60% and 70%).

The prior art, which is Korean Patent Application Publication No. 10-2004-0027746 published on Apr. 1, 2004 and entitled a “rising air generating chimney structure for wind power generation and typhoon control” is a technology regarding a steel equilateral triangular chimney which produces wind electricity and an artificial typhoon by using a gas burner and hot and humid air (vapor latent heat) as an energy source. it is assumed that the diameter of a chimney capable of producing an artificial typhoon is at least 100 km and the height of the chimney is at least 10 km. Accordingly, the prior art violates the logic that the size and suction force of a chimney are proportional to the height of the chimney, and the prior art cannot technically induce an artificial typhoon.

### DISCLOSURE

### Technical Problem

There is a need for a method and structure that can artificially generate a spiral air column in order to artificially and continuously disperse and weaken high-temperature and high-humidity and low-temperature dry generation energy of a tornado and yellowdust generated in a direction opposite to the rotational direction (the clockwise direction) of an anticyclone, i.e., in the rotation direction (the counterclockwise direction) of a cyclone, according to the principle of gears, the Torricelli principle and the Pascal principle (butterfly). There is a need for a generation method and generating structure that can artificially generate a spiral air column year-round in order to weaken while continuously dispersing the generated energy of a hurricane and a typhoon caused by volume expansion attributable to the temperature rise of high-temperature and high-humidity air in the equator region. The same is true of a land tornado and yellowdust.

There is a need for an artificial generating method and structure for powerful updrafts that can continuously adjust generation time without interruption while dispersing the number of generated natural tornadoes, hurricanes, yellowdust, and typhoons by generating an artificial tornado, hurricane, yellowdust and typhoon by sucking air from the ground and raising the air while passing the air through paths between the spiral coaxial generators including four coaxial cylinders and artificially weakening the generated collected low-pressure energy of a natural tornado, hurricane, yellowdust, and typhoon while dispersing them.

The present invention is a technology that can weaken powerful rising air such as a tornado, a hurricane, yellowdust and a typhoon generated in various parts of the world and causing the loss of many a lot of lives and property while artificially dispersing it without interruption, a technology that weakens the generation energy of the low temperature dry whistle wind, which is the generation energy of tornado and yellowdust, and the energy of the high temperature and high humidity trade wind which is the generation energy of hurricane and typhoon while dispersing it without interruption year-round, and a technology related to a spiral artificial generator for the artificial generation of a typhoon, yellowdust and a tornado that can artificially generate a spiral air pillar having a generation form identical to that of a tornado, a hurricane, yellowdust and a typhoon on a small scale in the same direction without interruption, wherein the size of the spiral artificial generator can be increased or decreased according to the basic module.

### Technical Solution

A wind, which is a tropospheric air movement, is a phenomenon in which air heated by solar energy attempts to maintain a dynamic equilibrium. Tornadoes, hurricanes, yellowdust and typhoons are meteorologically caused because the atmosphere is very unstable (due to the lapse rate of temperature). Low-temperature dry air is the main generating energy for tornadoes and yellowdust in nature, and high-temperature humid air (latency vapor) is the main generating energy for hurricanes and typhoons. Tornadoes, hurricanes, yellowdust and typhoons generate strong energy irregularly over large areas, but a large amount of observed data on the types and conditions of generation have been arranged.

In the doldrums of the equator in which the trade winds (floating winds) continue to rush, typhoons are not generated because the turning force is hardly applied. Accordingly, if the trade wind (flying wind) air that flocks strongly from the doldrums of the equator is a cyclone and does not rise up to the sky, it finds a way out. As a means by which a cyclone escapes, low-temperature hot and humid air is gathered to the source of a hurricane or typhoon, generates a hurricane or typhoon, and escapes with enormous wind speed.

The present invention artificially generates a powerful updraft such as a tornado, a hurricane, yellowdust, or typhoon by means of the spiral movement principle, the Pascal principle and the principle of chimneys without interruption, and the artificial and a small tornado, hurricane, yellowdust, or typhoon of the present invention generates an artificial air column which continuously lifts up air without interruption according to the principle that the force by which a chimney sucks air is proportional to the height of the chimney and wind power energy is proportional to the third power of wind speed. The spiral artificial generator constructed on land or at sea is naturally composed of four coaxial steel cylinders and thus naturally heated by solar heat, and a stainless steel plate and a heating coil installed in the inner circular structure of the spiral artificial generator are heated by environmentally-friendly solar cells and wind power generation. As the air inside the spiral artificial generator expands and continues to rise upward, the spiral movement of an upstream flow is powerfully generated, draws the air around the spiral artificial generator, raises the drawn air upward, and continues to push up the internal air inside the spiral artificial generator.

### Advantageous Effects

According to the present invention, the spiral artificial generator of the present invention that continuously generates the upward movement of air in accordance with the chimney principle, the Ekman spiral principle, the principle of gears, the Torricelli principle, and the Pascal principle, such as the butterfly effect, in a region having a westerly wind and an easterly wind (a trade wind) is constructed, and the air of a low-temperature dry westerly wind and the air of a hot/high-temperature easterly wind (a trade wind) enter the spiral manipulator of the present invention and continuously generate the upward movement of air in accordance with the chimney principle, the Ekman spiral principle and the Pascal principle such as the Torricelli effect and the butterfly effect without interruption. In this case, the rising high-temperature and high-humidity air and low-temperature dry air continues the upward movement under buoyancy as the temperature of the air is increased and the air is expanded by the spiral motion of the spiral artificial generator, and the air expands and continues its upward movement under buoyancy as latent heat is released by the condensation of water vapor absorbed by low-temperature and dry air and water vapor contained in hot and humid air.

According to the present invention, the spiral artificial generator that can artificially generate the spiral movement of air on land or at sea in a region where temperature is rising while rising air always flows in an area where a low-temperature dry and wet westerly wind and a hot and humid trade wind (an easterly wind) are present is constructed, and the loss of a lot of human lives and property is prevented by artificially distributing artificial small tornadoes, hurricanes, yellowdust and typhoons, and artificially adjusting the number of occurrences in order to artificially disperse the collection of hot and humid air and low-temperature dry air.

When the spiral artificial generator is constructed on land or at sea in an area from which a tornado, a hurricane, yellowdust or a typhoon is originated and generates a small artificial tornado, hurricane, yellowdust or typhoon, ambient high-temperature and high-humidity air and low-temperature dry air enter into the spiral artificial generator, and the energy of the tornado, hurricane, yellowdust, or typhoon around the spiral artificial generator is artificially dispersed and weakened, thereby reducing the scale of the generation of a tornado, a hurricane, yellowdust, or a typhoon because the generation of a tornado, a hurricane, yellowdust, or a typhoon cannot be generated strongly. When the door of the spiral artificial generator is closed and a small artificial tornado, hurricane, yellowdust or typhoon is generated, the small artificial tornado, hurricane, yellowdust or typhoon is continuously generated by opening the door of the spiral artificial generator, and the energy generated by hurricanes, yellowdust and typhoons is artificially weakened while being dissipated, thereby preventing the loss of a lot of lives and property.

### DESCRIPTION OF DRAWINGS

FIG. 1 is a perspective view of the present invention;

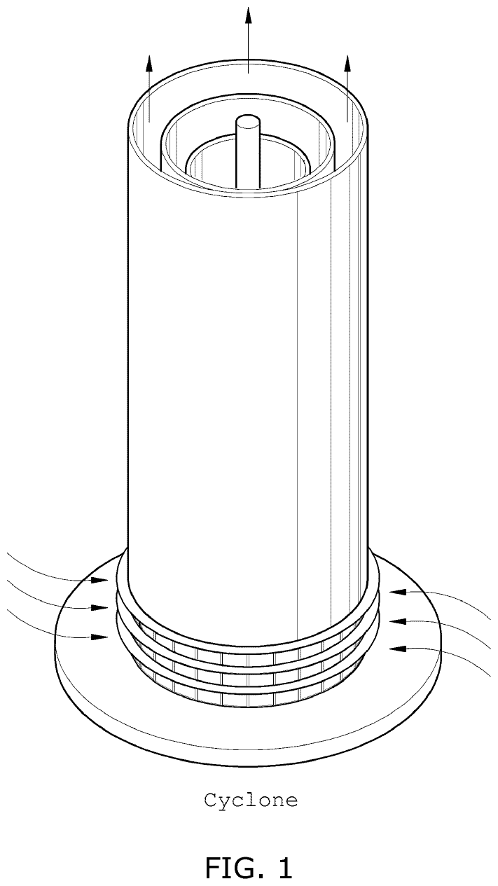

FIG. 2 is a view showing general low-pressure and high-pressure wind directions;

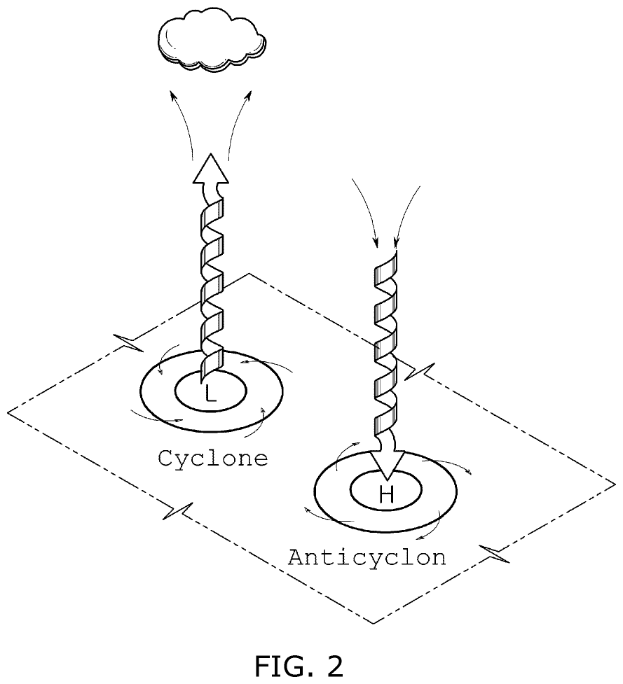

FIG. 3 is a sectional structural view of a typical typhoon;

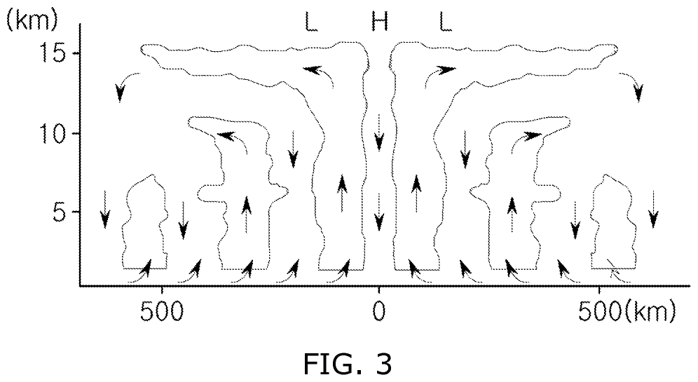

FIG. 4 is a sectional view of the present invention;

FIG. 5 is an air flow diagram of the present invention;

FIG. 6 is an air flow diagram of FIG. 5 in a plan view;

FIG. 7 is an enlarged sectional view of the upper part of the present invention;

FIG. 8 is an enlarged view of main parts of FIG. 7;

FIG. 9 is a partial sectional view showing the air movement of the present invention,

FIG. 10 is a sectional view showing a spiral staircase in the spiral artificial generator of the present invention;

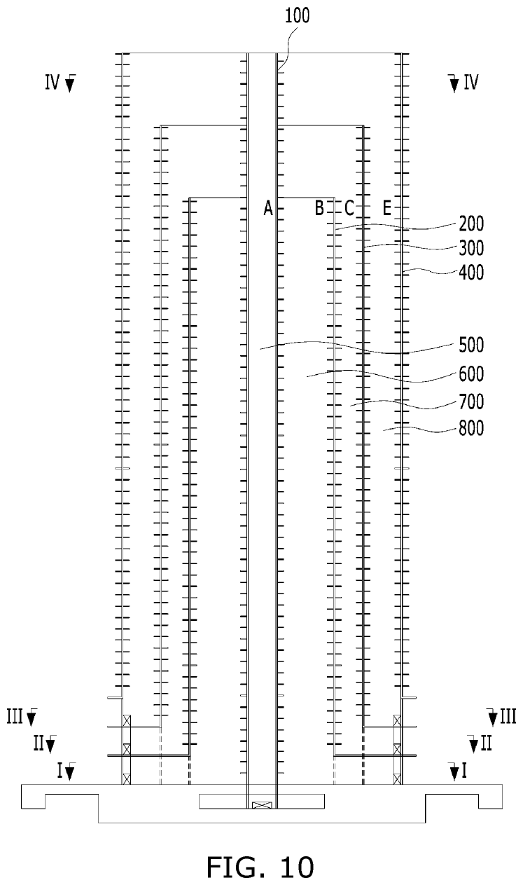

FIG. 11 is a plan view taken along line II of FIG. 10;

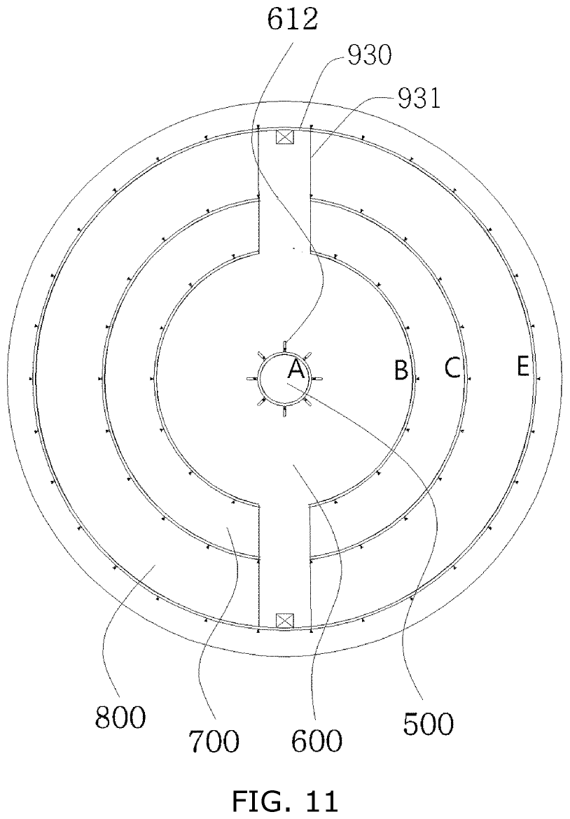

FIG. 12 is a plan view taken along the line II-II of FIG. 10;

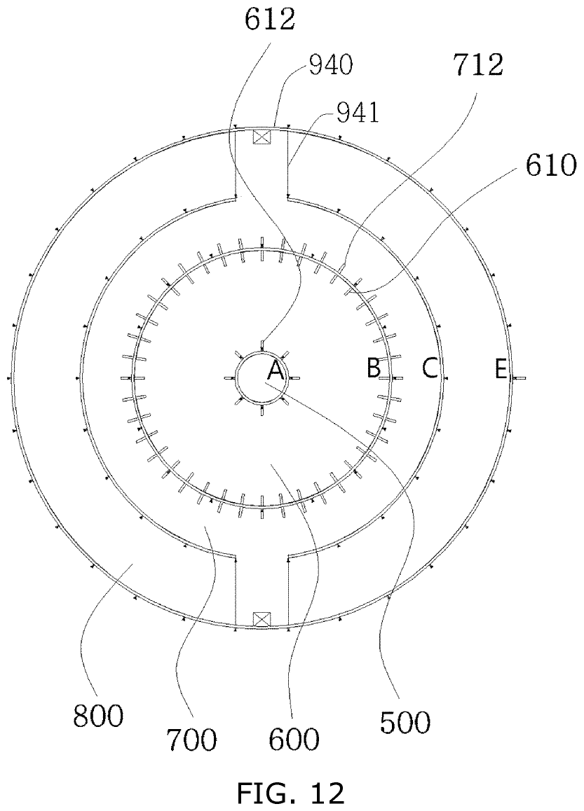

FIG. 13 is a plan view taken along line III-III of FIG. 10;

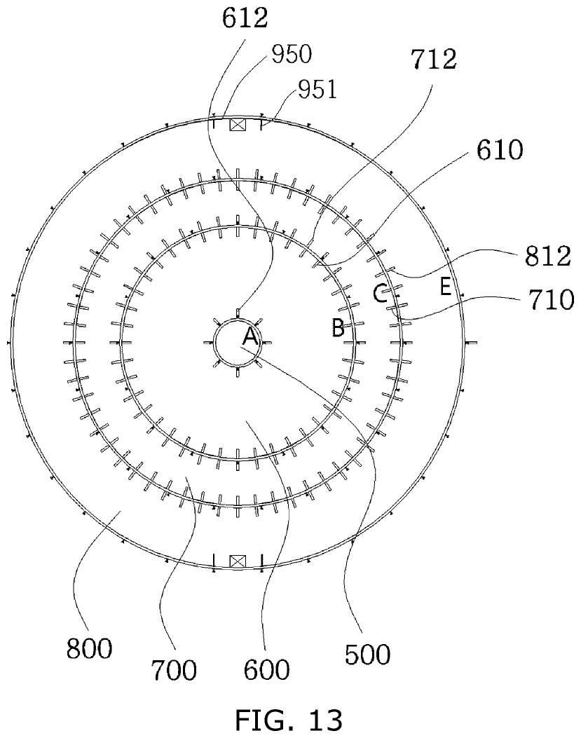

FIG. 14 is a plan view taken along the line IV-IV of FIG. 10; and

FIG. 15 is an explanatory view of an upper air bearing seen in the plan view of the present invention.

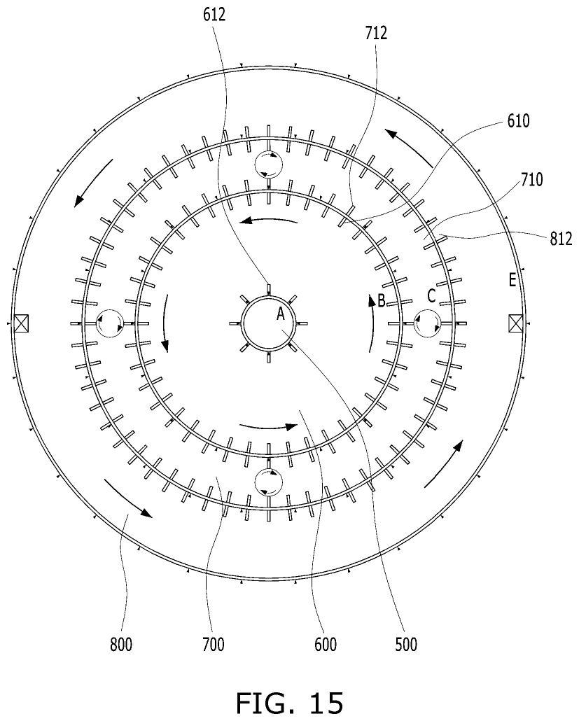

### MODE FOR INVENTION

1) The artificial upward air flow of a spiral artificial generator is continuously generated by the spiral motion of air, and the outer diameter D of the spiral artificial generator relative to the outer height H of the spiral artificial generator, determined for the structural safety of the spiral artificial generator against wind force, is calculated by D=0.382H (≈1H≈1.618≈1.618), which is a basic module formula in which the height H of the spiral artificial generator is successively divided twice at a golden ratio of 1.618.

(e.g., H152 m×D58 m, H199 m×D76 m, and H100 m×D38 m)

2) The spiral motion for the generation of the artificial upward air flow of the spiral artificial generator is strongly and continuously generated. When the diameter D of the spiral artificial generator, which is determined for the structural safety of the spiral artificial generator against wind force, is determined first, the outer height H of the spiral artificial generator is calculated by H=2.618D (≈1D×1.618×1.618), which is a basic module formula in which the diameter D of the spiral artificial generator is successively multiplied twice at a golden ratio of 1.618.

(e.g., H152 m×D58 m, H199 m×D76 m, and H100 m×D38 m)

3) The corresponding heights H₁ and H₂ of the second and third artificial generators B and C, which are the internal coaxial cylindrical structures of the spiral artificial generator, with respect to the determined height H of the spiral artificial generator are calculated by H₁=0.84H and H₂=0.92H, which are basic module formulas.

(e.g., 128 m≈0.84×152 m, and 140 m≈0.92×152 m)

4) For example, in order to actively induce a thunderstorm, a total of nine arrestors in three sets of three arrestors, which are made of silver (Ag) and in each of which a lightning rod protrudes from a funnel-type base, are installed on the top of the spiral artificial generator which artificially generates a natural tornado, hurricane, yellowdust and typhoon in small scale without interruption.

5) A separate tank configured to store silver (Ag), silicon, and water is installed separately from the underground structure of the spiral artificial generator underground, and is electrically connected to the arresters.

6) A stepped spiral blade which is fabricated at an angle of 45° (width=height) to generate the spiral motion of air is installed on the outer wall of the fourth artificial generator E of the spiral artificial generator at an angle of 45° (width=height). In order to supply environmentally friendly electricity to the spiral artificial generator, solar cells are installed on the outer wall of the spiral artificial generator in the south, east and west (in the southern hemisphere, the east, north and west). In case of need, when an inverter configured to generate AC power based on a charge battery voltage via a solar cell is installed, it is favorable for the driving of a generator and the generation of emergency power.

7) A door which can remotely control the inflow of air while being selectively opened and closed by electricity generated by the solar cells and wind power generation and in which a screen configured to prevent the inflow of garbage is installed to be selectively opened and closed is installed on the bottom of the cylindrical spiral artificial generator E. A door in which a screen is selectively opened and closed is also installed inside the bottom of the spiral artificial generator C. A door is also installed on the bottom of the cylindrical spiral artificial generator B. An entry passage leads to a corresponding passage.

8) Blowers which are driven by the solar cells and the wind power generation to suck air outside the spiral artificial generator into individual passages inside the second, third and fourth artificial generators B, C and E, which are second, third and fourth coaxial cylindrical structures, and to blow the air upward are installed on the bottoms of the second, third and fourth artificial generators B, C and E, which are coaxial cylindrical structures.

9) Stepped spiral blades which are fabricated at an angle of 45° (width=height) according to the Ekman spiral principle inside the second to fourth artificial generators B, C, and E are installed on the inner and outer walls of the second to fourth artificial generators at an angle of 45° (width=height), and artificially and strongly generate air bearings without interruption. Furthermore, the widths of the stepped spiral blades are calculated as 4% to 5% of the radius of the spiral artificial generator determined according to the basic form of the present invention by a basic module formula (e.g., D58 m≈2×4%≈1.2m), and are used for the installation work and maintenance of the spiral artificial generator.

10) For the air suction of the second to fourth artificial generators and the continuous spiral movement of the sucked air, a stepped spiral blade continuous upward is attached to opposite passage walls between the first and second artificial generators A and B, which are the first and second cylindrical structures of the spiral artificial generator. A stainless steel plate and a heating coil (which may be replaced with one of a carbon heater and a carbon mat, which are heating means) in which the height of a basic form is maintained at 36 m (≈152 m×24%; ranging from 12 m above the ground to 48 m above the ground), which is 24% of the height of the generator (H) of a spiral chimney, and which are heated by the supply of power generated by the solar cells and the wind power generation are installed, and act to expand while artificially heating incoming air, thereby strongly sucking and raising internal air. The reason for installing the stainless steel plate and the heating coil from 12 m of the basic form above the ground and limiting the upper installation limit to 48 m is that heating efficiency is deteriorated in that case.

11) Spiral motion blades which induce spiral wind directions in the same counterclockwise direction as the rotation directions of a tornado, a hurricane, yellowdust and a typhoon are installed in the inner passages of the second and fourth cylindrical generators B and E, which are second and fourth cylindrical structures. A spiral motion blade which induces a spiral wind direction in the same counterclockwise direction according to the principle of gears and Newton's law is installed in the inner passage of the third artificial generator C. The counterclockwise wind speeds of the second and fourth artificial generators B and E react with the clockwise wind speeds at the upper end of the third artificial generator C, thereby accelerating the counterclockwise wind speeds of the second and fourth artificial generators B and E according to the principle of gears and the air bearings. The reason for this is that the height of the third artificial generator C is set to the center of the height of the second and fourth artificial generators B and E, so that the halves of a clockwise wind direction passing over the top of the spiral artificial generator (C) are extinguished on both sides by accelerated wind directions passing over the tops of the second and fourth artificial generators B and E and the wind directions of the second and fourth artificial generators B and E are combined together according to the spiral motion principle and the principle of gears.

12) When the spiral artificial generator is constructed in the southern hemisphere of the earth, the stepped blade installed in the counterclockwise or clockwise direction on the inner wall of the spiral artificial generator forming the passage thereof is installed in the direction opposite to that in the northern hemisphere.

13) In order to prevent the cause of yellowdust, water spray equipment and tanks are installed in passages between the second, third and fourth artificial generators B, C and E, which are the basic second, third and fourth cylindrical structures, and the fine dust particles of yellowdust are collected and removed by water mist. Furthermore, the water supplied to the spraying equipment is purified and reused.

14) For a basic type of wind power generation, the main body of a wind power generator is installed on the inner circumference of the first artificial generator A having a combined wind power generator and regulator function, which is the first cylindrical structure, and the windmills of the wind generator are installed in the passages of the artificial generators B and C, which are the second and third cylindrical structures so that they are rotated by wind power.

15) A construction tower crane is installed inside the first artificial generator A, which is a basic cylindrical structure, for construction work and maintenance, an elevator is installed for the purpose of maintenance after construction, and dry air is dispersed over the air to predict the occurrence of a tornado, a hurricane, yellowdust, and a typhoon.

16) For the structural reinforcement of the spiral artificial generator, the retaining wall of the first artificial generator A, which is a cylindrical structure, is installed up to one fifth of the height H of the spiral artificial generator RC by using a reinforced concrete construction (RC), and the walls of the first generator A, which is a chimney-type structure, and the second, third and fourth artificial generators B, C and E, which are coaxial cylindrical structures, are reinforced to 24 m above the ground by using steel frames.

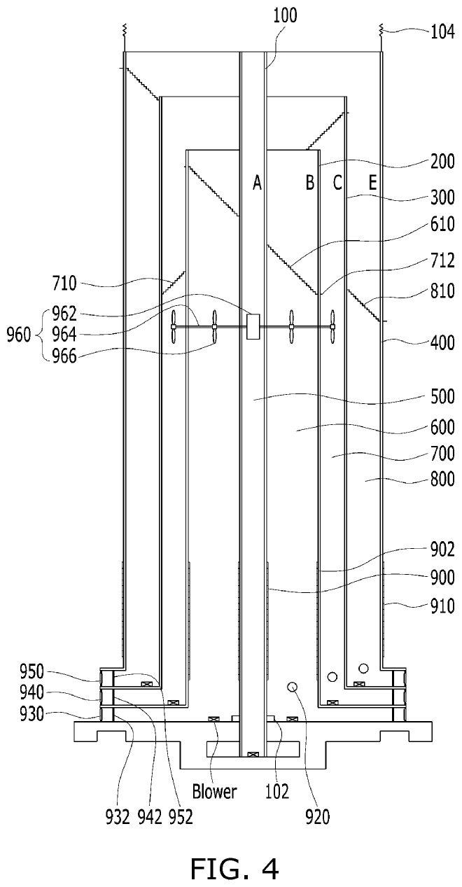

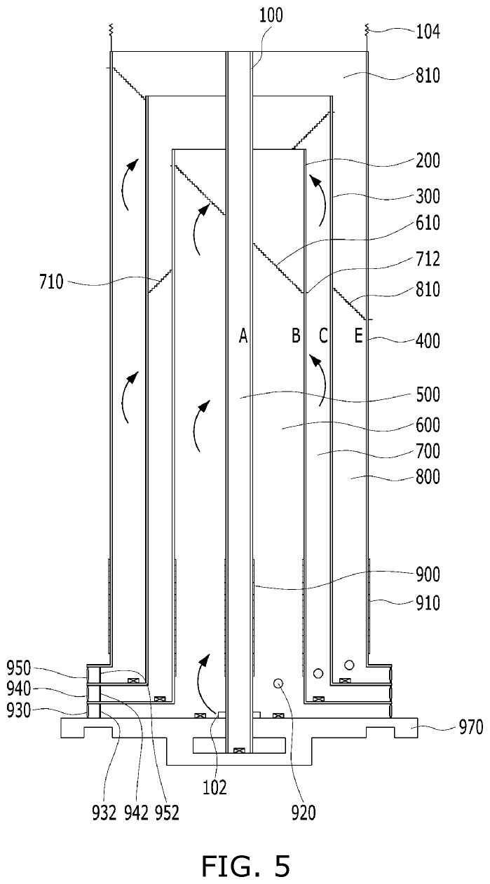

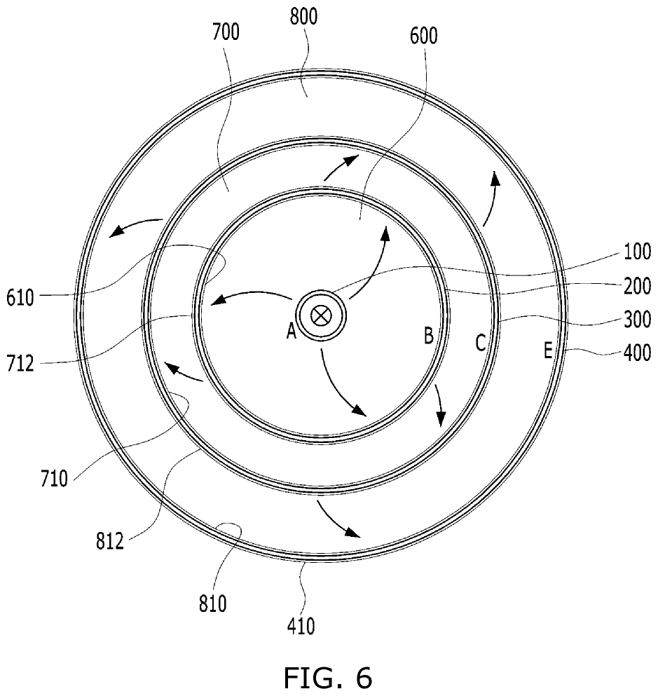

In connection with the descriptions in conjunction with FIGS. 4 to 9, when the outer height H is set to 152 m, the diameter D of the basic-type fourth artificial generator E is calculated as about 58 m (≈152 m×0.382) which is 0.382 (≈1.618≈1.618) times 152 m.

The present invention includes:

a first artificial generator 100 which has a second path inner staircase 612 configured to induce a counterclockwise wind direction on the outer surface thereof in order to correspond to a second path outer staircase 610, i.e., a screw-type spiral staircase (in the southern hemisphere, a right-handed screw-type spiral staircase), on the inner surface of the second artificial generator 200 which is coaxial with the basic-type fourth artificial generator E and provides a second path 600, which forms a chimney-shaped first path 500 therein, and in which a combined wind power generator and regulator is installed;

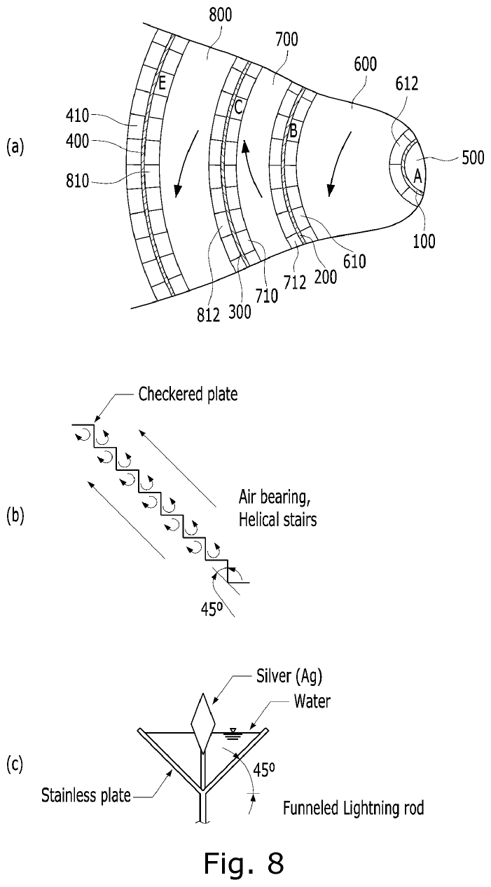

the second artificial generator 200 which is lower than the first artificial generator 100, which provides the second path 600 configured to suck external air from the outer side of the lower end of a fourth artificial generator 400 through the lower end of a third artificial generator 300 and raise the external air in a counterclockwise direction, which has a screw-type spiral second path outer staircase 610 on the inner wall thereof, and which induces rising while performing counterclockwise rotation on a plane, as indicated by the directions of the arrows of FIG. 8;

the third artificial generator 300 which has a diameter larger than and is coaxial with the second artificial generator 200, which has a height higher than the second artificial generator 200, which has a spiral third path outer staircase 710 along the wall surface of the inner circumferential portion thereof such that external air is sucked from the outer side of the lower end of the third artificial generator 400 to be isolated from the second path 600 and the third path 700 and is raised through the third path 700 between the outer surface of the second artificial generator 200 and the inner surface of the third artificial generator 300 in a clockwise screw direction, and which induces rising while performing clockwise rotation on a plane;

a fourth artificial generator 400 which has a diameter larger than and is coaxial with the third artificial generator 300, which has a height higher than the third artificial generator 300, which has the height as the first artificial generator 100, which has a fourth path outer staircase 810 on the inner circumferential portion thereof such that external air is sucked from the outer side of the lower end of the fourth artificial generator 400 to a fourth path 800 between the outer surface of the third artificial generator 300 and the inner surface of the fourth artificial generator 400 and is raised in a counterclockwise screw direction, and which induces rising while performing counterclockwise rotation on a plane; and

a base frame 970 which fastens the lower ends of the first to fourth artificial generators 100, 200, 300 and 400 to the ground surface; wherein the paths 931, 941 and 951 of the second to fourth artificial generators 200, 300 and 400 are configured to suck external air in the state of being isolated from each other in the lower end of the fourth artificial generator 400.

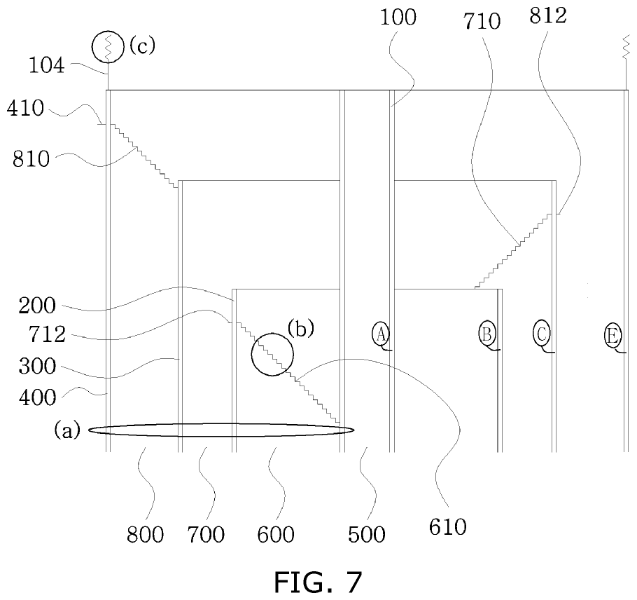

FIG. 8(a) is an enlarged view of the important portion of FIG. 7 in a plan view, FIG. 8(b) is an enlarged view of portion (b) of FIG. 7, and FIG. 8(c) is an enlarged view of portion (c) of FIG. 7.

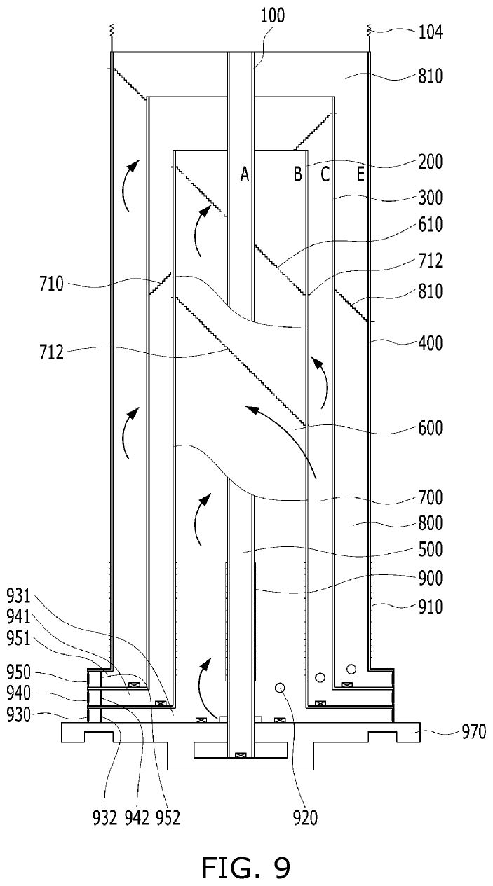

As shown in FIG. 9, on the base frame 970 are installed a first door 930 which is installed in an entrance path connected to the second path 600 in the lower end of the fourth artificial generator 400 and which supplies external air to the second path 600 counterclockwise when it is opened;

a second door 940 which is installed in a second floor entrance path connected to the third path 700 at a second floor location of the lower end of the fourth artificial generator 400 isolated from the entrance path of the first door 930 and which supplies air rotating clockwise in the third path 700 so that the air is raised; and

a third door 950 which is installed in a third floor entrance path connected to the fourth path 800 at a third floor location of the lower end of the fourth artificial generator 400 isolated from the second floor entrance path 941 of the second door 940 and which supplies external air such that air rotating clockwise in the fourth path 800 is raised; and

the isolated entrance path, second floor entrance path and third floor entrance path are radially spaced apart from each other in the lower ends of the corresponding second artificial generator 200, third artificial generator 300 and fourth artificial generator 400, and the first door 930 is installed in the entrance path 931, the second door 920 is installed in the second floor entrance path 941, and the third door 950 is installed in the third floor entrance path 951.

A stainless plate 900 which is a metal plate heated by a heating coil 902 in order to generate strong raising force by heating introduced air in an early stage is installed on the outer surface of the lower portion of the first artificial generator 100 and the inner surface of the lower portion of the second artificial generator 200 which form the second path 600.

The body 962 of the wind power generator 960 is installed in the first path 500 which is the inner circumferential portion of the first artificial generator 100, as shown in FIG. 4;

the wind power generator 960 further includes: a rotating shaft 964 which extends from the body 962 to the second path 600 and the third path 700, which is equipped with a rotating blade 966, and which is rotated to operate a wind power generator 96; and

a rotating blade 966 which receives rising air having passed through the second path 600 and the third path 700 and is rotated in order to provide rotating force to the rotating shaft 964.

Spray nozzles 920 each having a water spraying function for the prevention of yellowdust are added to the bottoms of the second path 600 to the fourth path 800.

The second path outer staircase 610, the third path outer staircase 710, and the fourth path outer staircase 810 are formed in spiral shapes and are installed on the outer side walls of the second to fourth paths 600, 700 and 800 between the first to fourth artificial generators 100, 200, 300 and 400, and the second path inner staircase 612, the third path inner staircase 712, and the fourth path inner staircase 812 are formed in spiral shapes and are installed inner side walls functioning to form the second to fourth paths 600, 700 and 800 between the first to fourth artificial generators 100, 200, 300 and 400; and

The inner staircase 612 of the second path, the inner staircase 712 of the third path, and the inner staircase 812 of the fourth path corresponding to the second path outer staircase 610, the third path outer staircase 710, and the fourth path outer staircase 810 are installed on inner walls over separated distances in the spatial widthwise directions of the corresponding second to fourth paths 600, 700 and 800, and the heights and bottoms of the staircases are the same and configured to form an inclination of 45°, as shown in FIG. 8(b).

In the present invention, basically, the second to fourth generators 200, 300 and 400 are coaxial with the first artificial generator 100 around the first artificial generator 100 while having increasing diameters, the second to fourth paths 600, 700 and 800 corresponding to the respective second to fourth artificial generators 200, 300 and 400 suck ambient air in the ground surface portions, air is introduced from a portion around the bottom of the fourth artificial generator 400 to the center thereof by suction force rotating simultaneously in the clockwise or counterclockwise direction along spiral stairs, simultaneous raising is performed on the second to fourth paths 600, 700 and 800, and the speed of rotationally raised wind is increased due to an increase in temperature and the expansion of air in an upward direction because the forces which cause accelerated spiral raising are added together by air bearing action attributable to the principle of gears, shown in FIG. 8(b), based on the widths and heights of the spiral staircases.

This increases the wind speed from the ground through the coaxial configuration, the height difference configuration and the spiral staircase configuration of the first to fourth artificial generators in an upward direction from the ground, thereby providing the generation of a tornado, a hurricane, yellowdust, or a typhoon similar the above process.

The second path 600 between the first artificial generator 100 and the second artificial generator 200 has a small rotation radius but a wide space, and thus high-speed rotation is induced by using the first artificial generator 100 as a rotating axis.

The radius of rotation of the third path 700 between the second artificial generator 200 and the third artificial generator 300 is larger than that of the second path 600, and thus causes raising and high-speed rotation by means of air bearing action attributable to the principle of gears of the third path outer staircase 710 and the third path inner staircase 712 in a left-handed screw direction (a clockwise direction) in a plane while inducing high-speed rotation. However, since the fourth path 800 is higher than the third path 700, the rotation direction of the high-speed rotational air attributable to the fourth passage 800 is changed on the upper end of the third artificial generator 300, the air is accelerated by means of external gear action and air bearing action, the direction of the air becomes the same as high-speed rotating air in the second path, and the air generates internal gear action, is accelerated, and acts to be subjected to double acceleration action to combine counterclockwise coaxial rotations having passed through the second path 600 and the fourth path 800 into one.

The fourth path 800 between the third artificial generator 300 and the fourth artificial generator 400 has a narrower spatial width than the second path 600 and has a larger radius of rotation than the third path 700, and thus causes raising and high-speed rotation in a counterclockwise direction by means of the internal gear action of the fourth path outer staircase 810 and the fourth path inner staircase 812 while inducing high-speed rotation. Since the height of the fourth artificial generator 400 is higher than that of the second artificial generator 200 and corresponding air is air rotating in the same counterclockwise direction, combination is performed by means of internal gear action and strong air movement occurs in the counterclockwise direction in the plane on the top of the second artificial generator 200, which strongly influences an ambient wind direction and an ambient wind speed in accordance with the law of causality, the spiral principle, the Torricelli principle, the butterfly effect, and the Pascal principle.

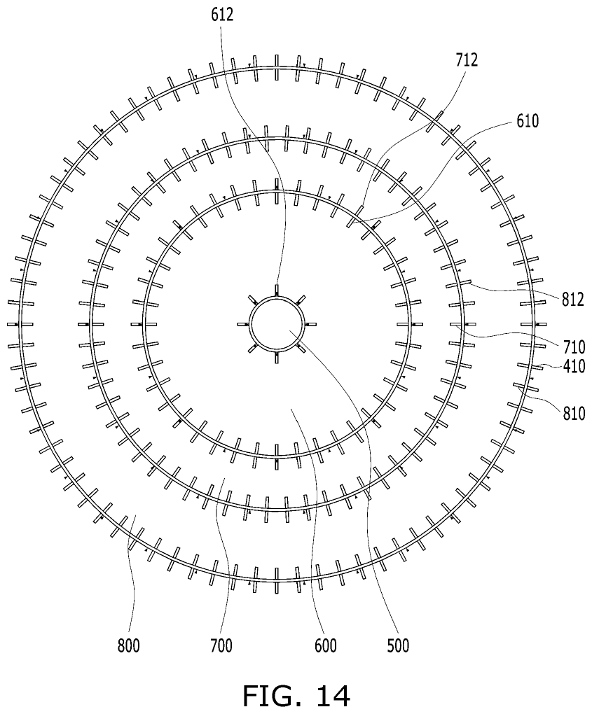

In addition, as shown in FIG. 14, although rotation in a counterclockwise and raising are performed in the second path 600 and rotation in the clockwise direction and raising are performed in the third path 700, the boundary surfaces of the upper end portions of the second path 600 and the third path 700 acts to accelerate counterclockwise rotation in the second path 600 while causing rotation in the clockwise direction, i.e., a different rotation direction, by means of external gear action and air bearing action. The reason for this is that the width of the third path 700 is narrower than that of the second path 600, and thus clockwise rotation in the third path 700 performs lubrication action and acceleration action while performing rotation in the opposite direction on the boundary surface of the upper end due to external gear action and air bearing action.

Although rotation in a counterclockwise direction and raising are performed in the fourth path 600 and rotation in the clockwise direction and raising are performed in the third path 700, the boundary surfaces of the upper end portions of the second path 600 and the third path 700 act to accelerate the counterclockwise rotation of the second path 600 while performing rotation in a different rotation direction by means of external gear action and air bearing action. The reason for this is that the width of the third path 700 is narrower than that of the second path 600 and the height of the fourth artificial generator 400 is lower than that of the third artificial generator 300, and thus clockwise rotation in the third path 700 performs lubrication action and acceleration action while performing rotation in the opposite direction on the boundary surface of the upper end portion by means of external gear action and air bearing action.

The rotational energy in the counterclockwise direction through the second path 600 via lubrication action attributable to external gear action and air bearing action through the third path 700 and the rotational energy of the counterclockwise rotating air through the fourth path 600 via lubrication action and acceleration action attributable to external gear action and air bearing action through the upper end of the third path 700 are combined on the top without resistance and decrease to function to increase rotational energy. 102 is an outlet configured to perform discharge from the lower end of the first path 500 to the second path 600, is opened when necessary such that high-pressure air ascending from the upper end of the first path 500 to the lower end thereof may enhance the function of the second path 600.

1. A spiral artificial generator for artificial generation of a tornado, a hurricane, yellowdust, or a typhoon, the spiral artificial generator being constructed on land or at sea in a northern or southern hemisphere from which a tornado, a hurricane, yellowdust, or a typhoon originates, the spiral artificial generator for generation of an updraft artificially generating a small artificial tornado, hurricane, yellowdust, or typhoon in accordance with an identical principle weakening generation energy of a tornado, a hurricane, yellowdust or a typhoon while artificially distributing the generation energy,
wherein a diameter D of the spiral artificial generator is selected by a basic module formula D=0.382H obtained by dividing a selected height H of the spiral artificial generator by a golden ratio of 1.618 twice in succession, a module formula H=2.618D opposite to the basic module formula is used when the diameter D of the spiral artificial generator is selected first, funnel-shaped arresters made of silver (Ag) are basically installed at a top of the spiral artificial generator, a solar cell heat collecting plate is installed on an outer wall of the top, and a door configured to be selectively opened and closed by solar cells and wind power generation, a blower configured to blow air, sucked through the door, to the artificial generator, and a stainless steel plate and heating coil configured to heat inner walls of the paths are installed on a bottom of the spiral artificial generator, thereby forming a basic form of the spiral artificial generator.

2. A spiral artificial generator for artificial generation of a tornado, a hurricane, yellowdust, or a typhoon,
wherein in order to artificially generate a powerful artificial rising current by constructing a spiral artificial generator on land or at sea in a northern or southern hemisphere which is rich in a tornado, a hurricane, yellowdust, or a typhoon, first to fourth artificial generators (A, B, C, E), which are four coaxial cylindrical structures each having a stepped spiral blade in an internal structure of the spiral artificial generator, are included, stepped spiral blades are basically installed on an inner wall of a first path between the first and second artificial generators (A and B), which are the first and second cylindrical structures and an inner wall of a third path between the third and fourth artificial generators (C and E), which are the third and fourth cylindrical structures, in a counterclockwise direction (in the southern hemisphere, a clockwise direction), respectively, in order to continuously generate spiral motion of air, a stepped spiral blade is installed on an inner wall of the third path between the second and third artificial generators (B and C) in a clockwise direction (in the southern hemisphere, a counterclockwise direction) in a plane in order to reinforce artificial spiral motion of the second and fourth cylindrical structures, and doors configured to be selectively opened and closed to separately suck external air are installed at lower ends of the second to fourth artificial generators (B, C and E) of the coaxial cylindrical structure, respectively, thereby forming a basic form of the spiral artificial generator.

3. The spiral artificial generator of claim 2, wherein a diameter D of the fourth artificial generator for strongly and continuously generating spiral motion of the spiral artificial generator for generation of an artificial rising air current is selected by a basic module formula D=0.382H (≈1H≈1.618≈1.618) obtained by dividing a determined height H of the spiral artificial generator by a golden ratio of 1.618 twice in succession.

4. The spiral artificial generator of claim 2, wherein when the diameter D of the fourth artificial generator (E) basically determined to strongly and continuously generate the spiral motion of the spiral artificial generator for generation of an artificial rising air current is selected first, a height H of the spiral artificial generator is calculated by a basic formula H=2.618D (≈1D×1.618×1.618) obtained by multiplying the selected diameter D of the spiral artificial generator by the golden ratio of 1.618 twice in succession.

5. The spiral artificial generator of claim 2, wherein in order to artificially and strongly generate the spiral motion of the spiral artificial generator for generation of an artificial rising air current without interruption, heights H₁ and H₂ of the second and third artificial generators (B and C), which are coaxial cylindrical structures, with respect to the external height (H) of the fourth artificial generator (E) are selected by basic formulas H₁=0.84×H and H₂=0.92×H, respectively.

6. The spiral artificial generator of claim 1, wherein the lightning arresters each have a structure in which a lightning rod protrudes from a funnel-type base, and include a total of nine arrestors in three sets of three arrestors made of silver (Ag) and distributed and installed at the top of the artificial generator.

7. The spiral artificial generator of claim 2, wherein a stepped spiral blade configured to artificially generate spiral motion of air is installed on an outer wall of the fourth artificial generator (E), and solar cell heat collecting plates are installed on south, east, and west sides (in the southern hemisphere, east, north, and west sides).

8. The spiral artificial generator of claim 2, wherein the door in the lower end of the fourth artificial generator (E) include three layers and selectively opens and closes corresponding entrance paths, the respective entrance paths are connected to the second to fourth paths (600, 700 and 800) of the second to four artificial generators (B, C and E), and blowers configured to blow lower air to upper ends of the second to four artificial generators (B, C and E) are installed in the entrance paths.

9. The spiral artificial generator of claim 8, wherein a screen configured to prevent inflow of garbage is added to the door installed at a lower end of the fourth artificial generator (E) corresponding to lower ends of the second to fourth artificial generators (B, C, and E).

10. The spiral artificial generator of claim 1, wherein the stepped spiral blades made at an angle of 45° (width=height) to strongly, artificially and continuously generate the spiral movement of air in accordance with an Ekman spiral principle are installed at an angle of 45° (width=height) inside the spiral artificial generator, and are configured to generate air bearings on spiral staircases, and the spiral staircases, which are the spiral blades, are also used for repair and maintenance.

11. The spiral artificial generator of claim 2, wherein stepped spiral blades fabricated at an angle raging from 45° to 59° (width=height) are installed in paths between inner walls of the second and fourth artificial generators B and E, which are the second and fourth cylindrical structures, in order to generate a spiral wind direction in the counterclockwise direction in a plane which is identical to a rotation direction of a tornado, a hurricane, yellowdust, or a typhoon, a stepped spiral blade fabricated at an angle ranging from 45° to 59° (width=height) is installed on an inner wall of a path of the third artificial generator (C) in order to raise a spiral wind direction in a clockwise direction in a plane in an inner wall path of the third artificial generator (C), and a counterclockwise wind speed in inner wall-side paths of the second and fourth artificial generators (B and E) is configured such that a clockwise wind speed in a path of the third artificial generator (C) acts to be mutually reactive, spiral, and gear-wise and strongly accelerates rising air of the second and fourth generators (B and E).

12. The spiral artificial generator of claim 11, wherein a width of the stepped spiral blade is calculated by a formula D58 m÷2×4%≈1.2 m obtained by multiplying a radius of the basic artificial generator by 4% to 5%.

13. The spiral artificial generator of claim 11, wherein the cylindrical stainless steel plates and the heating coils are installed on portions corresponding to 36 m (≈152m×4%; in a range of 12 m above a ground to 48 m above ground) which corresponds to 24% of the height H of the spiral artificial generator on the stepped spiral blades of the first and second artificial generators (A and B), and are configured to increase a rising speed of external air while heating the external air.

14. The spiral artificial generator of claim 2, wherein in order to remove a cause of the yellowdust, water spray facilities are additionally installed in the paths of the coaxial cylindrical structure of the second, third, and four artificial generators (B, C and E), and are configured to accumulate fine dust particles of the yellowdust by means of water mist.

15. The spiral artificial generator of claim 2, wherein a main body of a wind power generator is installed on the cylindrical structure of the first artificial generator (A), and a windmill configured to be installed on a rotating shaft of the main body of the wind power generator is located in an inner side of the second and third artificial generators (B and C).

16. The spiral artificial generator of claim 2, wherein the stepped spiral blades made at an angle of 45° (width=height) to strongly, artificially and continuously generate the spiral movement of air in accordance with an Ekman spiral principle are installed at an angle of 45° (width=height) inside the spiral artificial generator, and are configured to generate air bearings on spiral staircases, and the spiral staircases, which are the spiral blades, are also used for repair and maintenance.

17. The spiral artificial generator of claim 10, wherein stepped spiral blades fabricated at an angle raging from 45° to 59° (width=height) are installed in paths between inner walls of the second and fourth artificial generators B and E, which are the second and fourth cylindrical structures, in order to generate a spiral wind direction in the counterclockwise direction in a plane which is identical to a rotation direction of a tornado, a hurricane, yellowdust, or a typhoon, a stepped spiral blade fabricated at an angle ranging from 45° to 59° (width=height) is installed on an inner wall of a path of the third artificial generator (C) in order to raise a spiral wind direction in a clockwise direction in a plane in an inner wall path of the third artificial generator (C), and a counterclockwise wind speed in inner wall-side paths of the second and fourth artificial generators (B and E) is configured such that a clockwise wind speed in a path of the third artificial generator (C) acts to be mutually reactive, spiral, and gear-wise and strongly accelerates rising air of the second and fourth generators (B and E).
